(19) United States
(12) Patent Application Publication
(10) Pub. No.: US 2026/0010322 A1
(43) Pub. Date: Jan. 8, 2026

(54) DATA PROCESSING APPARATUS, STORAGE MEDIUM, AND CONTROL METHOD

(71) Applicant: CANON KABUSHIKI KAISHA, Tokyo (JP)

(72) Inventor: JUMPEI TAKEICHI, Kanagawa (JP)

(21) Appl. No.: 19/257,153

(22) Filed: Jul. 1, 2025

(30) Foreign Application Priority Data
Jul. 3, 2024 (JP) 2024-107515

(51) Int. Cl. G06F 3/12

(52) U.S. Cl. CPC G06F 3/1253; G06F 3/1205; G06F 3/1285

(57) ABSTRACT

A control method of a data processing apparatus determines a configurable setting item for printing according to a printing flow selected by a user regardless of information on print target data. Print items including a print item required by the user is thereby displayed. Good visibility is also obtained by not displaying all of configurable setting items for printing.

### BACKGROUND

### Field of the Technology

The present disclosure relates to a data processing apparatus, a storage medium, and a control method.

### Description of the Related Art

In recent years, as mobile devices have become more widely used, an increasing number of enterprises have adopted mobile devices as business terminals. A print or scan instruction can be issued to an image processing apparatus, such as a multi-function peripheral or a printer, using a mobile terminal with an installed application for instructing the image processing to perform processing. For example, a user selects a file from a folder and configures print settings via the application on the mobile terminal and then transmits a print instruction to the image processing apparatus. Upon receipt of the instruction, the image processing apparatus performs printing based on the settings.

Some applications prompt the user to select whether to perform image printing or document printing prior to selecting a file. By prompting the user to select in advance whether to perform image printing or document printing, the selectable files can be limited to those in suitable formats, thereby improving usability. Further, there are cases where the configurable print settings and default print settings differ between image printing and document printing. For example, picture correction and border settings may be supported for image printing but not for document printing. Conversely, a double-sided printing setting may be supported for document printing but not for picture printing. By displaying only the settings that are most likely to be used by the user, the operability of the setting items can be improved, thereby enhancing usability.

Japanese Patent Application Laid-Open No. 2019-179326 discusses a method in which, in a case where picture printing is set, an image is analyzed and when the image exhibits a characteristic similar to that of a standard document, settings suitable for document printing are applied.

In the method discussed in Japanese Patent Application Laid-Open No. 2019-179326, image analysis imposes a processing load on the mobile terminal. Additionally, the configurable print settings can vary depending on the analysis result, which may confuse the user.

### SUMMARY

Embodiments of the present disclosure are directed to providing a method for configuring a suitable print setting in a case where a user issues a print instruction.

According to embodiments of the present disclosure, a control method of a data processing apparatus includes executing a first display control to display a screen configured to prompt a user to select whether to perform document printing or picture printing, executing a second display control to display a file selection screen used to select a file to be printed, the file selection screen including a file corresponding to the printing selected on the screen, and transmitting an instruction to print the file selected on the file selection screen to an image processing apparatus. In a case where the document printing is selected on the screen, a print setting corresponding to the document printing is set, whereas in a case where the picture printing is selected on the screen, a print setting corresponding to the picture printing is set, and in a case where the document printing is selected on the screen and a file indicating a picture is selected on the file selection screen, the print setting corresponding to the document printing is set.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating a system configuration.

FIG. 2 is a block diagram illustrating a hardware configuration of a data processing apparatus.

FIG. 3 is a block diagram illustrating a hardware configuration of an image processing apparatus.

FIG. 4 is a block diagram illustrating a software configuration of the data processing apparatus.

FIGS. 5A to 5D are diagrams illustrating examples of screens displayed by an application running on the data processing apparatus.

FIGS. 6A to 6D are diagrams illustrating examples of screens displayed by the data processing apparatus.

FIGS. 7A and 7B are diagrams illustrating a flowchart of a process for selecting a picture file and issuing a print instruction in a picture printing flow.

FIGS. 8A and 8B are diagrams illustrating a flowchart of a process for selecting a file and issuing a print instruction in a case where a document file is selected in a document printing flow.

FIG. 9 is a flowchart illustrating a process for issuing a print instruction in a case where a picture file is selected in a document printing flow.

### DESCRIPTION OF THE EMBODIMENTS

Exemplary embodiments of the present disclosure will be described in detail with reference to the attached drawings. Not all combinations of features described in the exemplary embodiments are necessarily essential to the technical solution of the present disclosure.

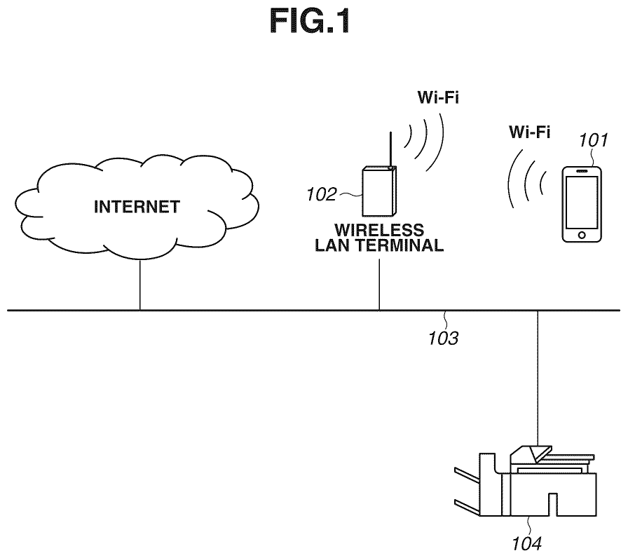

A first exemplary embodiment will now be described in detail with reference to the drawings. FIG. 1 is a diagram illustrating a configuration of an information processing system according to the present exemplary embodiment. In FIG. 1, a data processing apparatus 101 is used to transmit a print or scan job to an image processing apparatus 104, and receives various user operations. The data processing apparatus 101 is, for example, a mobile terminal such as a smartphone or a tablet. The image processing apparatus 104 can include a copy function, a print function, and a fax transmission function, in addition to a scan function, or can be a single-function apparatus including only one of these functions.

A local area network (LAN) 103 is a LAN to which the data processing apparatus 101 and the image processing apparatus 104 are connected. The data processing apparatus 101 and the image processing apparatus 104 communicate with each other via the LAN 103. There is also a wireless LAN terminal 102. The wireless LAN terminal 102 is a wireless LAN base unit including general network/router functions and provides a wireless LAN within a home or office. The data processing apparatus 101 can also participate in the LAN 103 via the wireless LAN terminal 102 by enabling a wireless LAN function. When the data processing apparatus 101 enters a wireless LAN area provided by the wireless LAN terminal 102, the data processing apparatus 101 can automatically participate in the network of the LAN 103 using authentication information preset in the data processing apparatus 101. The data processing apparatus 101 and the image processing apparatus 104 can also communicate directly with each other without relying on the wireless LAN terminal 102. Although only a single image processing apparatus is illustrated in FIG. 1, this is not intended to be a limitation, and a plurality of image processing apparatuses may be connected to the LAN 103.

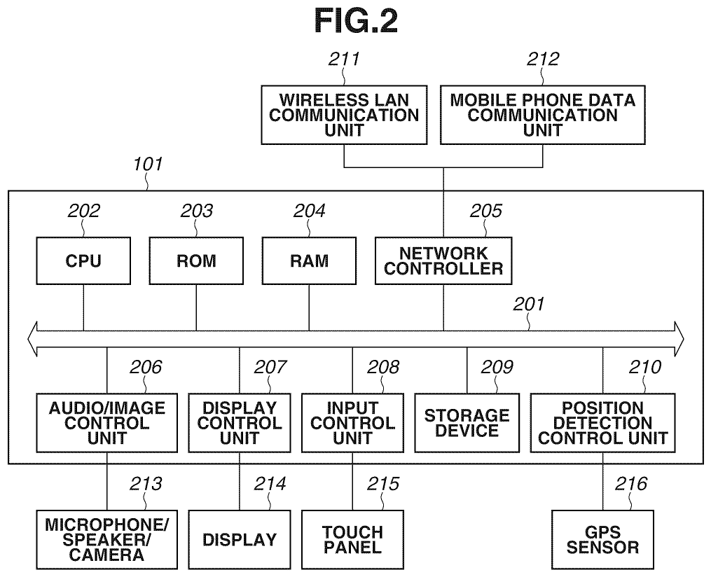

FIG. 2 is a block diagram illustrating a hardware configuration of the data processing apparatus 101 illustrated in FIG. 1. An operating system for a compact terminal and a program for controlling voice communication or data communication can also be executed on the data processing apparatus 101. Alternatively, the data processing apparatus 101 can also be a personal computer (PC) that does not include an audio/image control unit 206 and a microphone/speaker/camera 213, a position detection control unit 210, a GPS sensor 216, or a mobile phone data communication unit 212, which will be described below.

Each hardware component is connected to a system bus 201. The operating system for the data processing apparatus 101 and an application for controlling voice communication and data communication are stored in a read-only memory (ROM) 203 and can be executed by a central processing unit (CPU) 202. The application for controlling data communication can be an application configured to exchange various types of data with the image processing apparatus 104, email software, or a web browser.

A RAM 204 is a memory used for program execution and serves as a work memory area for an application during program execution. The RAM 204 is also a memory for temporarily storing data that must be temporarily stored during execution of a program by an application. A storage device 209 is a non-volatile storage device storing various operation mode settings and operation logs that need to be retained even after the data processing apparatus 101 is restarted.

A network controller 205 controls communication performed by a wireless LAN communication unit 211 to participate in the network of the LAN 103 via the wireless LAN terminal 102, and also controls communication performed by the mobile phone data communication unit 212 to participate in a network provided by a mobile carrier. The audio/image control unit 206 is used, for example, when a voice communication application is activated and the user is on a call. The microphone/speaker 213 inputs and outputs audio data, and the audio/image control unit 206 mediates between the audio data and an audio data control program. The audio/image control unit 206 also mediates between image data captured and generated by the camera 213 and an image data control program.

A display control unit 207 controls information output via a display 214 of the data processing apparatus 101. An input control unit 208 controls information specified by the user using a button or a touch panel 215 of the data processing apparatus 101. The application running on the data processing apparatus 101 provides the user with network communication information and various types of information about the data processing apparatus 101 using the audio/image control unit 206, the display control unit 207, and the input control unit 208.

The position detection control unit 210 acquires position information about the data processing apparatus 101 from the GPS sensor 216 and provides the position information to the operating system. These controls are controlled by the operating system (OS) running on the CPU 202.

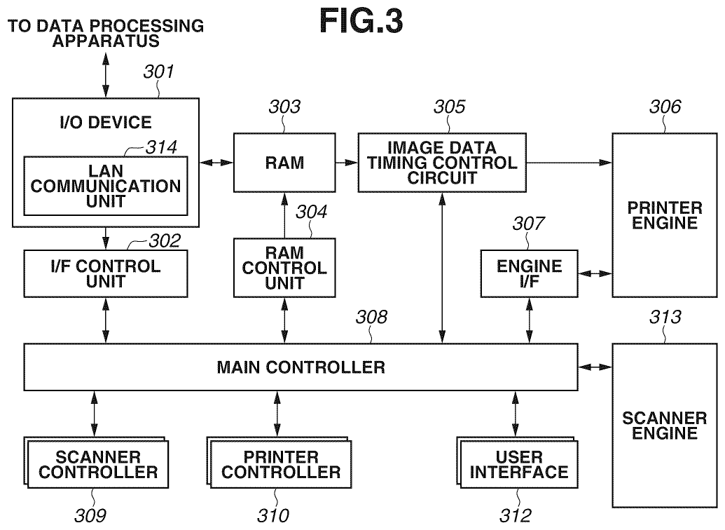

FIG. 3 is a block diagram illustrating a hardware configuration of the image processing apparatus 104 illustrated in FIG. 1. This illustrates an example of a multi-function peripheral (MFP) having a scanner function and a printer function.

In FIG. 3, an input/output (I/O) device 301 includes a LAN communication unit 314. The LAN communication unit 314 can communicate with the data processing apparatus 101 via the network (LAN) 103. For example, image data generated through scanning by the image processing apparatus 104 is transmitted to the data processing apparatus 101 via the LAN 103. A plurality of I/O devices 301 can be included to support a plurality of connection forms. The image processing apparatus 104 passes a device identifier (device ID) or a scanned image to the data processing apparatus 101 through the I/O device 301. The image processing apparatus 104 receives various control commands from the data processing apparatus 101 and performs processing. An interface (I/F) control unit 302 controls the issuance of device IDs for processing systems, such as a scanner, printer, or fax, within the image processing apparatus 104. A RAM 303 is a primary storage device and is used to store external data such as a control command acquired by the I/O device 301 and image data (hereinafter, referred to as “image”) scanned by a scanner engine 313. The RAM 303 is also used to store an image loaded by a printer controller 310 before it is passed to a printer engine 306. The allocation management of the RAM 303 is performed by a RAM control unit 304. An image data timing control circuit 305 is a device that outputs an image loaded by the printer controller 310 or an image captured by the scanner engine 313 and loaded into the RAM 303 in synchronization with the rotation of the printer engine 306. The printer engine 306 is a device that develops an image on an output medium such as paper. A main controller 308 performs various controls on the printer engine 306 via an engine I/F 307. The main controller 308 is a key module for control and performs suitable distribution processing of control languages received from the data processing apparatus 101 via the I/O device 301 to a scanner controller 309 and the printer controller 310. The main controller 308 also receives an instruction from each controller or a user interface 312 and controls the printer engine 306 or the scanner engine 313. The scanner controller 309 decomposes a scan control command received from the data processing apparatus 101 into an internal execution command that can be interpreted by the main controller 308. The scanner controller 309 also changes an image scanned by the scanner engine 313 into a scan control command. The printer controller 310 decomposes a page description language (PDL) received as a print job from the data processing apparatus 101 into an internal execution command, including a raster image, that can be interpreted by the main controller 308. The raster image is conveyed to the printer engine 306 and printed on an output medium such as paper.

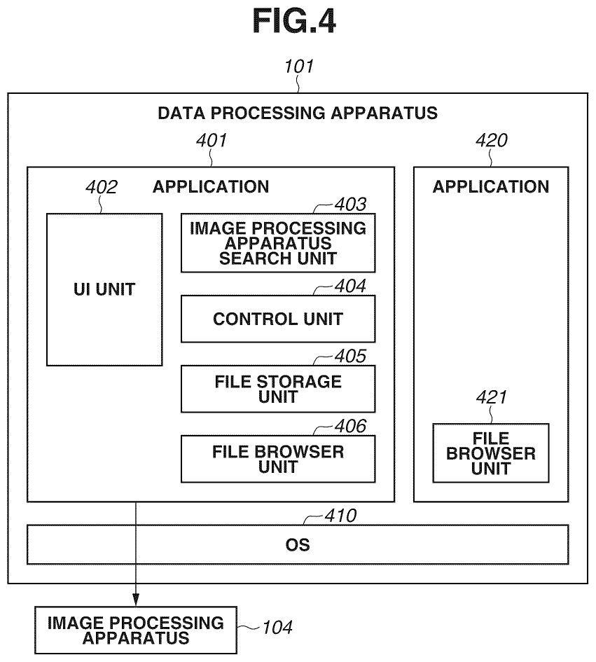

FIG. 4 is a block diagram illustrating a software configuration of the data processing apparatus 101 illustrated in FIG. 1. The processing of each component is realized by the CPU 202 by executing a program stored in the ROM 203 or the storage device 209.

An OS 410 is basic software for controlling the overall operation of the data processing apparatus 101. For example, Android® provided by Google is used.

An application 401 is an application that is executed on the data processing apparatus 101 and installed in the ROM 203 as an application configured to run on the OS 410. The application 401 issues print or scan instructions to the image processing apparatus 104. For example, the application 401 selects a file, such as image data, stored in a storage device of the data processing apparatus 101 and issues an instruction to print the selected file to the image processing apparatus 104. The application 401 also includes a function to issue a scan instruction to the image processing apparatus 104 and a function to store an image captured by the camera 213 of the data processing apparatus 101. A UI unit 402 is a UI unit of the application 401 and provides a user interface configured to prompt the user to set and execute the functions of the application 401. An image processing apparatus search unit 403 is an image processing apparatus search unit and searches for a network device on the LAN 103 to which the data processing apparatus 101 is connected, or a network device available for direct communication. More specifically, the image processing apparatus search unit 403 searches for an image processing apparatus to which the data processing apparatus 101 can issue a print or scan instruction. A control unit 404 controls various processes performed by the application 401. For example, the control unit 404 generates a print or scan job and transmits the generated job to an image processing apparatus available for communication. The control unit 404 performs a process for storing data generated by the application 401 or the like. A file storage unit 405 stores a file generated or acquired by the application 401. For example, the file storage unit 405 receives image data generated through scanning by the image processing apparatus 104 from the image processing apparatus 104 and stores the received image data. The data stored in the file storage unit 405 can be stored in a common storage area of the data processing apparatus 101 so that the data can be referenced and used by an application other than the application 401, or the data can be stored in a dedicated storage area of the application 401 so that the data cannot be referenced or used by an application other than the application 401.

For example, when the application 401 is activated for the first time, a folder corresponding to the file storage unit 405 is automatically generated. Thereafter, image data generated through processing by the application 401, such as image data (scanned data) generated through scanning by the image processing apparatus 104 or image data (captured data) generated through imaging by the camera 213 is stored in the generated folder.

A file browser unit 406 browses files stored in a storage such as the storage device of the data processing apparatus 101. For example, the file browser unit 406 provides a list of files stored in the storage device 209 to prompt the user to select print data to be transmitted to the image processing apparatus 104. This file browser function can provide a method for prompting the user to select a picture or document file stored in the data processing apparatus 101. Primarily, the following two methods can be considered.

The first method is a method to generate a UI screen that displays a file list in an application and prompt the user to select a file. In this method, the vendor or developer of the application implements a proprietary file browser function, thereby providing a file browsing function specific to the application. For example, a list in a predesignated folder (e.g., a folder used as a default storage destination or target folder for file selection by the application) can be displayed on a default selection screen. In contrast, a system for accessing a cloud storage or external memory card must be implemented, which entails design effort and cost. Further, each time an application programming interface (API) for accessing a cloud storage or an external memory card is updated, the application must be modified, so that maintenance costs for the application are incurred. Furthermore, a change in the OS specifications can lead to a decrease in usability. Hereinafter, the file browser function using this method will be referred to as “in-application file browser function”, and a screen displayed by the file browser function using this method will be referred to as “in-application file selection screen”.

The second method uses an OS-provided file browsing function. In this case, the application can invoke the file browsing function of the OS and acquire a file selected by the file browsing function of the OS. Accordingly, the application performs file selection by utilizing a system provided by the OS without implementing a system for accessing an external memory card or a cloud storage. In this method, the OS-provided file browsing function is designed on the premise that it will be invoked by various applications, so that detailed settings specific to individual applications cannot be configured. The OS-provided file browsing function herein refers, for example, to a Photo Picker, which is a picture selection screen provided by Android. The Photo Picker displays a list of files in a predetermined file format (herein, image format) extracted from files stored in a storage such as the storage device 209 of the data processing apparatus 101. Hereinafter, the file browser function using this method will be referred to as “OS-provided file browsing function”, and a screen displayed by the file browser function using this method will be referred to as “OS-provided file selection screen”.

An application other than the application 401 is also installed on the OS of the data processing apparatus 101. For example, an application 420 is an application having a function similar to that of the application 401 and includes a file browser unit 421. The applications installed on the data processing apparatus 101 are not limited to those described above, and other applications can also be installed.

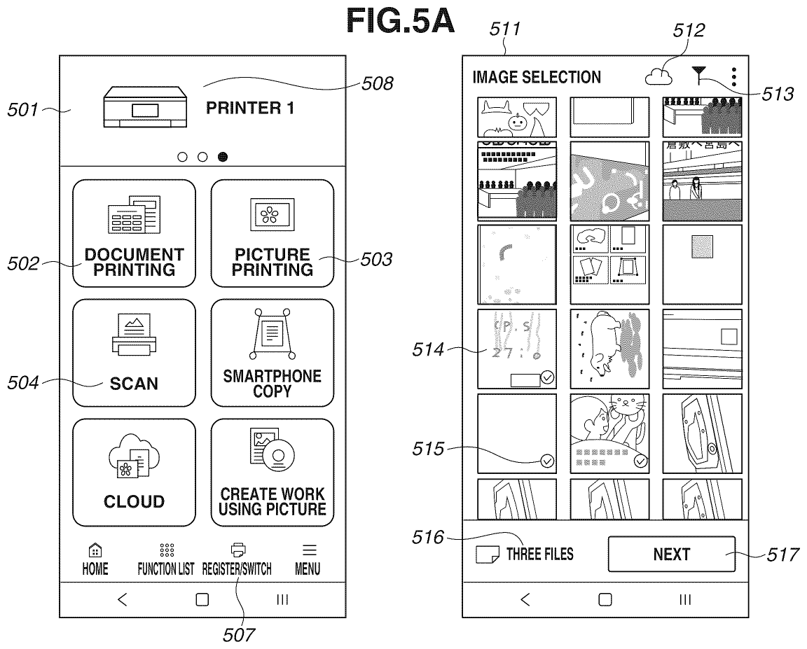

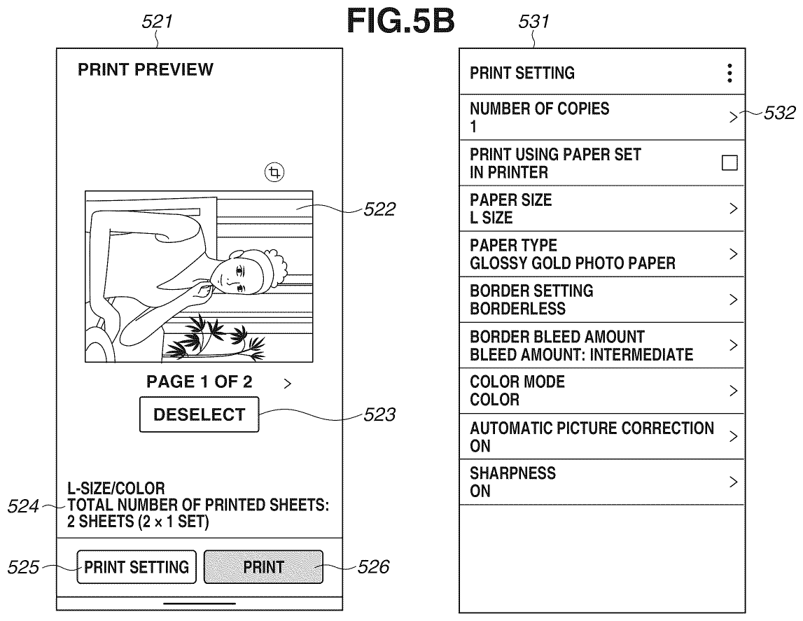

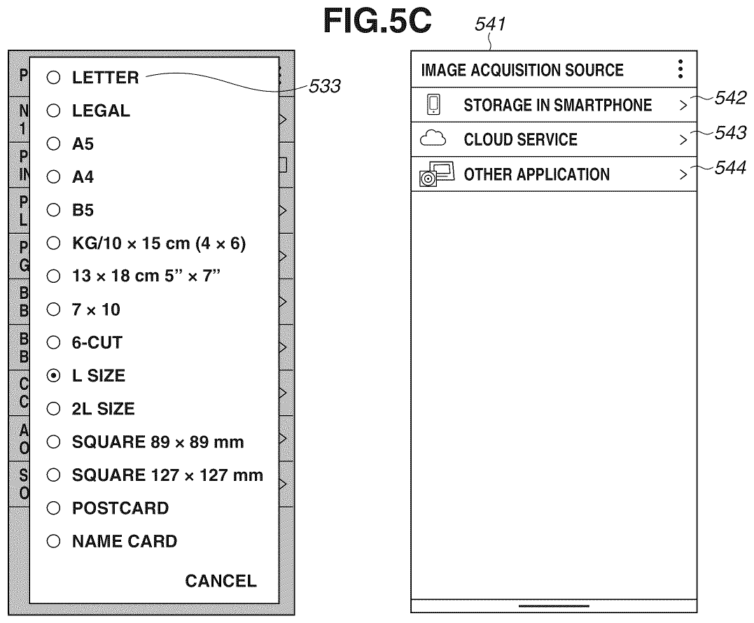

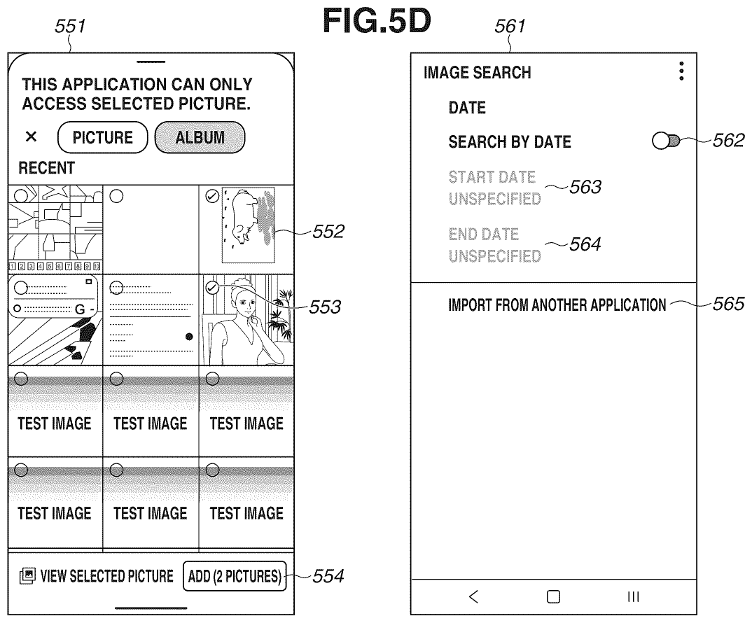

Screen transitions from the selection of a picture file to be printed to the printing of the selected file by the application 401 will be described with reference to FIGS. 5A to 5D

A menu screen 501 is a top menu screen that is a home screen of the application 401 and displayed, for example, immediately after the application 401 is activated. A user operation for selecting a function to be executed is received via the menu screen 501. A document printing button 502 is a button used to instruct the image processing apparatus 104 to print a document. Selection of the document printing button 502 causes a transition to a document acquisition source selection screen 601 for selecting an acquisition source for the file to be printed. The document acquisition source selection screen 601 is displayed by the processing of the file browser unit 406.

A picture printing button 503 is a button used to instruct the image processing apparatus 104 to print a picture. Selection of the picture printing button 503 causes a transition to a screen for selecting a picture to be printed. The screen is displayed by the processing of the file browser unit 406.

A scan button 504 is a button used to instruct the image processing apparatus 104 to scan. When the user selects the scan button 504, configures various settings, and then selects a scan execution button, the image processing apparatus 104 returns image data generated by executing a scanning process to the data processing apparatus 101. The file storage unit 405 performs a process of storing the acquired image data in a predetermined folder.

Image processing apparatus information 508 displays information about an image processing apparatus to which the application 401 issues an instruction to print or scan. In this case, an icon and name of the image processing apparatus are displayed.

A registration/switching button 507 is a button used to register or switch an image processing apparatus to which an instruction is to be issued. When the registration/switching button 507 is selected, the image processing apparatus search unit 403 searches for, for example, an image processing apparatus on the LAN 103.

An in-application file selection screen 511 is a screen for selecting a picture file to be printed. The in-application file selection screen 511 is displayed upon selection of the picture printing button 503. The picture file is, for example, a file in Joint Photographic Experts Group (JPEG) or Portable Network Graphics (PNG) format. The in-application file selection screen 511 is a screen displayed by an internal file browser function of the application 401 and displays a picture file list stored in the storage. For example, picture files contained in a predetermined folder of the storage device 209 are displayed in a list by default.

A cloud button 512 is a display item used to select a picture file to be printed from a cloud storage. A filter button 513 is a button for changing a condition under which a file is displayed in a list and for filtering the files to be displayed.

A picture file 514 is a thumbnail image of a picture file contained in the target folder. A check mark 515 is a display item displayed on a thumbnail image to make the picture file selected by the user identifiable. A number-of-files 516 is a display item that indicates the number of files selected by the user. In picture printing, a plurality of picture files can be selected.

Selection of a next button 517 causes a transition to a print instruction screen 521. At this time, each file selected by the user on the in-application file selection screen 511 becomes a printing target.

The print instruction screen 521 is a screen for instructing an image forming apparatus to perform printing. An image 522 displays a preview image of a file to be printed. In a case where there is a plurality of files to be printed, the next file can be previewed by a user operation. A deselect button 523 is a button for deselecting a file to be printed. A print setting 524 is a display item that allows the user to check the current print setting. This display content may display all or some of the configurable items. A print setting button 525 is a button for configuring a print setting. A print button 526 is a button for transmitting a print job including the selected file to the target image processing apparatus.

Selection of the print setting button 525 causes a transition to a print setting screen 531 for picture printing.

The print setting screen 531 for picture printing is a screen for configuring a setting value for use in printing with the image forming apparatus. In this case, a print setting suitable for picture printing is set as a default (initial) setting. A print setting item 532 for picture printing is an area where a setting item for picture printing is displayed. Each print setting item for picture printing is selectable, and in a case where a print setting item for picture printing is selected, the corresponding setting value list is displayed. For example, in a case where “paper size” is selected from the print setting items for picture printing, a configurable item list 533 for picture printing is displayed as an option. In a case where an option is selected from the configurable item list 533 by the user, the print setting is updated, and a transition to the print setting screen 531 for picture printing occurs. On the other hand, in a case where an item “cancel” is selected, the originally selected print setting is retained. Although the configurable item list 533 for picture printing is displayed in a dialog format on the print setting screen 531 for picture printing herein, the configurable item list 533 for picture printing may alternatively be displayed as a separate screen. Further, the print setting items displayed in the print setting item 532 for picture printing vary depending on the target image forming apparatus. Specifically, the configurable items vary depending on the capability of the image forming apparatus. For example, no border setting is displayed for an image forming apparatus that does not support the border setting. Further, the options displayed upon selection of the print setting items also vary depending on the capability of the image forming apparatus. For example, in a case where the image forming apparatus supports printing on paper sizes up to A1, paper sizes up to A1 are selected and displayed, whereas in a case where the image forming apparatus supports printing on paper sizes only up to A3, only paper sizes up to A3 are displayed, so that the options differ. For each item in the print setting item 532 for picture printing, a setting value considered suitable for picture printing is preset as an initial value. For example, picture paper is set as the initial value for paper type, and the default settings for automatic picture correction and sharpness are set to ON. The initial value for the paper size may also be changed depending on the region in which the image forming apparatus is used. For example, L size may be set as the initial value in Japan, while KG size may be set as the initial value in the United States. Setting the initial values to those considered suitable for picture printing settings as described above can improve usability. Further, in a case where the user has previously performed printing, the setting values used for the last picture printing may be stored, or the user may be allowed to configure and store default print settings.

A picture acquisition source selection screen 541 is a screen for selecting an acquisition source of a picture file to be printed. The picture acquisition source selection screen 541 is displayed upon selection of the picture printing button 503. Which of the in-application file selection screen 511 or the picture acquisition source selection screen 541 is displayed upon selection of the picture printing button 503 is determined based on a condition. For example, beginning with Android version 14, an application is required to obtain user permission for each file in the storage to access the file. In other words, in Android version 14, adopting a configuration in which a file is selected from the in-application file selection screen 511 requires the user to perform a permission operation for each selection, which is cumbersome. Conversely, in a case where a file is selected from an OS-provided file selection screen, user permission is not required. Thus, a configuration is adopted in which the version of the OS (Android) of the data processing apparatus 101 on which the application 401 is running is determined, and in a case where the version is later than 14, the in-application file selection screen 511 is displayed upon selection of the picture printing button 503, whereas in a case where the version is 14 or higher, the picture acquisition source selection screen 541 is displayed upon selection of the picture printing button 503. Therefore, in a case where the OS specifications impose no restrictions on application file access, the in-application file selection screen 511, which is a user-friendly file selection screen, is provided. Conversely, in a case where the OS specifications impose a restriction on application file access, an OS-provided file selection screen is used, thereby eliminating the need to request user permission each time.

The description of FIG. 5 will be resumed. The picture acquisition source selection screen 541 includes an in-terminal button 542 configured to designate the internal storage of the data processing apparatus 101 as a picture file acquisition source. The picture acquisition source selection screen 541 further includes a cloud service button 543 configured to designate a cloud service 1 as a picture file acquisition source and an other-application button 544 configured to designate another application different from the application 401 as a picture file acquisition source.

An OS-provided file selection screen 551 is a screen for selecting a picture file to be printed. The OS-provided file selection screen 551 is displayed upon selection of the in-terminal button 542. The OS-provided file selection screen 551 is an OS-provided screen, for example, a Photo Picker screen provided by Android. A picture file 552 is a thumbnail image of a picture file contained in the target folder. A check mark 553 is a display item displayed on a thumbnail image to make the picture file selected by the user identifiable.

Selection of an add button 554 causes a transition to the print instruction screen 521. At this time, each file selected by the user on the OS-provided file selection screen 551 becomes a printing target. In a case where printing is executed through the print instruction screen 521, a print job including the file selected on the OS-provided file selection screen 551 is transmitted to the image forming apparatus.

A condition setting screen 561 is a screen configured to set a condition for a file to be displayed on the in-application file selection screen 511. The condition setting screen 561 is displayed upon selection of the filter button 513.

Here, an example is described where the date of file generation is set as a condition. A search-by-date button 562 is a button for selecting whether to set the date of file generation as a condition for a file to be displayed. Enabling the search-by-date button 562 sets the date of file generation as a condition for a file to be displayed. A start date 563 and an end date 564 are display items for setting the start and end dates that define the range of generation dates for files to be displayed. Each file generated between the start date 563 and the end date 564 is displayed on the in-application file selection screen 511. Further, the condition setting screen 561 also displays an import button 565 for importing a file from another application. In a case where the import button 565 is selected, a file imported from another application can be printed. As described above, the in-application file selection screen 511 can include an application-specific browsing function, such as filtering files by date. On the other hand, the OS-provided file selection screen 551 cannot provide a proprietary browser function, such as filtering by date. Although filtering by date is described herein as an example of an application-specific function, this is not intended to be a limitation, and the file list may be sorted by creation date and time, and in addition to the thumbnail images, the file names, file sizes, and/or creation dates and times of the files may also be displayed.

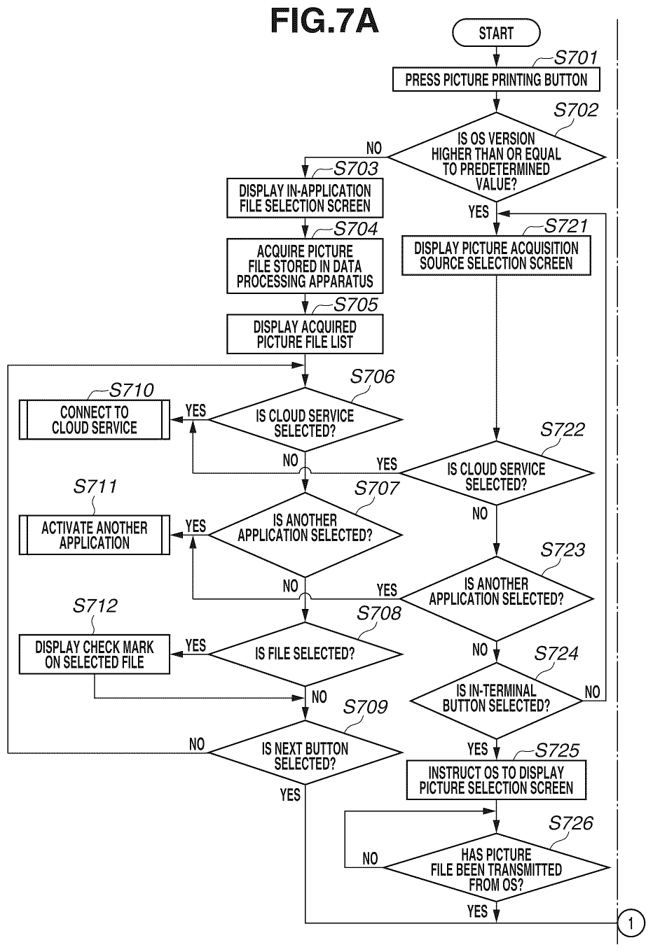

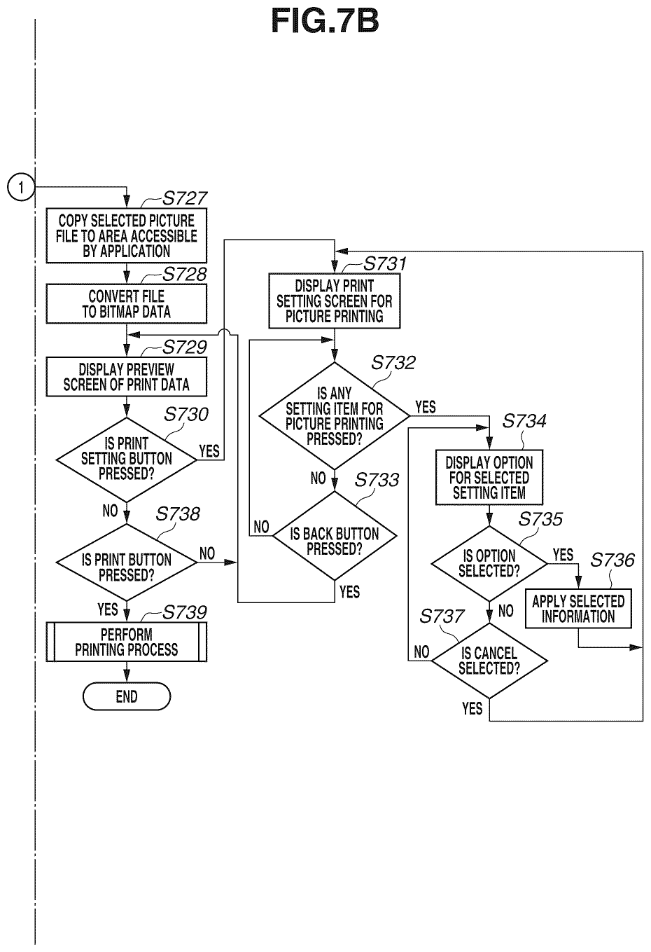

A process for selecting a picture file to be printed and printing the selected file by the application 401 will be described with reference to a flowchart in FIG. 7. Each step in FIG. 7 is realized by the CPU 202 by executing a program stored in the ROM 203 or the storage device 209.

In step S701, the UI unit 402 receives a selection of the picture printing button 503. Then, in step S702, the control unit 404 acquires the version of the OS on which the application 401 is running, i.e., the version of the OS running on the data processing apparatus 101, and determines whether the acquired version is higher than or equal to a predetermined value. In a case where the version is determined to be higher than or equal to the predetermined value (YES in step S702), the processing proceeds to step S721. Otherwise (NO in step S702), the processing proceeds to step S703. For example, in a case where the OS version is higher than or equal to Android 14, the processing proceeds to step S721, whereas in a case where the OS version is lower than Android 13, the processing proceeds to step S703. Although the version of the OS is used for the determination, this is not a limiting configuration. For example, a configuration that determines whether there is a restriction on access to files in the OS may be employed.

In step S703, the file browser unit 406 displays an in-application file selection screen. In step S704, the file browser unit 406 acquires a picture file stored in the storage device 209 of the data processing apparatus 101. Then, in step S705, the file browser unit 406 displays an acquired picture file list. In this case, for example, the in-application file selection screen 511 is displayed.

In step S706, the control unit 404 determines whether an instruction to select a file from the cloud is received from the user. For example, the control unit 404 determines whether the cloud button 512 is selected, and in a case where the cloud button 512 is selected (YES in step S706), the processing proceeds to step S710, whereas in a case where the cloud button 512 is not selected (NO in step S706), the processing proceeds to step S707. In step S710, the control unit 404 connects to the cloud service and receives a user operation to select a file from the file list stored in the cloud storage. In a case where a selection of a file is received, the file may be set as a file to be printed, and the processing may proceed to step S709 or S727.

In step S707, the control unit 404 determines whether an instruction to select a file from another application is received from the user. For example, the control unit 404 determines whether the import button 565 is selected, and in a case where the import button 565 is selected (YES in step S707), the processing proceeds to step S711, whereas in a case where the import button 565 is not selected (NO in step S707), the processing proceeds to step S708. In step S711, the control unit 404 activates the other application and receives a user operation to select a file from the file list stored in the other application. In a case where a selection of a file is received, the file may be set as a file to be printed, and the processing proceed to step S709 or S727.

In step S708, the control unit 404 determines whether a file is selected on the in-application file selection screen. In a case where the control unit 404 determines that a file is selected (YES in step S708), the processing proceeds to step S712. Otherwise (NO in step S708), the processing proceeds to step S709. In step S712, the UI unit 402 displays the check mark 515 on a thumbnail image of the file selected in step S708, and the processing proceeds to step S709.

In step S709, the control unit 404 determines whether the next button 517 is selected on the in-application file selection screen. In a case where the next button 517 is selected (YES in step S709), the processing proceeds to step S727. Otherwise (NO in step S709), the processing returns to step S706.

In step S721, the UI unit 402 displays the picture acquisition source selection screen 541. In step S722, the control unit 404 determines whether the cloud service button 543 is selected on the picture acquisition source selection screen 541. In a case where the cloud service button 543 is selected (YES in step S722), the processing proceeds to step S710. Otherwise (NO in step S722), the processing proceeds to step S723. In step S723, the control unit 404 determines whether the other-application button 544 is selected on the picture acquisition source selection screen 541. In a case where the other-application button 544 is selected (YES in step S723), the processing proceeds to step S711. Otherwise (NO in step S723), the processing proceeds to step S724. In step S724, the control unit 404 determines whether the in-terminal button 542 is selected on the picture acquisition source selection screen 541. In a case where the in-terminal button 542 is selected (YES in step S723), the processing proceeds to step S725. Otherwise (NO in step S723), the processing returns to step S721.

In step S725, the file browser unit 406 instructs the OS 410 to display an OS-provided file selection screen. For example, the file browser unit 406 instructs the OS 410 to display a Photo Picker screen.

In step S726, the control unit 404 determines whether a picture file has been transmitted from the OS 410. In a case where a picture file has been transmitted (YES in step S726), the processing proceeds to step S727. Otherwise (NO in step S726), the process of step S726 is repeated. At this time, in a case where a file is selected and then the add button 554 is selected on the OS-provided file selection screen 551 by the user, the selected file is transmitted from the OS 410 to the application 401.

In step S727, the control unit 404 copies the picture file selected by the user to a memory area accessible by the application 401. In step S728, the control unit 404 converts the selected picture file to bitmap data. Then, in step S729, the UI unit 402 displays a preview screen of the selected file.

In step S730, the control unit 404 determines whether the print setting button 525 is selected. In a case where the print setting button 525 is selected (YES in step S730), the processing proceeds to step S731. Otherwise (NO in step S730), the processing proceeds to step S738.

In step S731, the UI unit 402 displays the print setting screen 531 for picture printing. In step S732, the control unit 404 determines whether any item from the print setting item 532 for picture printing is pressed. In a case where an item is pressed (YES in step S732), the processing proceeds to step S734, whereas in a case where no item is pressed (NO in step S732), the processing proceeds to step S733. In step S733, the control unit 404 determines whether a back button is pressed. Although an operation on the back button is described herein, a close button or a ‘x’ button may alternatively be provided, and the similar operation can be applied. In a case where the back button is pressed (YES in step S733), the processing proceeds to step S729, whereas in a case where the back button is not pressed (NO in step S733), the processing proceeds to step S732.

In step S734, the UI unit 402 displays the configurable item list 533 for picture printing to display an option for the selected print setting item.

In step S735, the control unit 404 determines whether an option is selected from the configurable item list 533 for picture printing.

In a case where an option is selected (YES in step S735), the processing proceeds to step S736. Otherwise (NO in step S735), the processing proceeds to step S737. In step S736, the control unit 404 stores the selected option in the RAM 204. Thereafter, the control unit 404 reads information stored in the RAM 204, transmits the information to the UI unit 402, updates the selected value of the print setting item 532 for picture printing, and displays the print setting screen 531 for picture printing.

In step S737, the control unit 404 determines whether the item “cancel” is selected. In a case where item “cancel” is selected (YES in step S737), the processing proceeds to step S731. Otherwise (NO in step S737), the processing proceeds to step S734.

In step S738, the control unit 404 determines whether the print button 526 is selected. In a case where the print button 526 is selected (YES in step S738), the processing proceeds to step S739. Otherwise (NO in step S738), the processing returns to step S729.

In step S739, the control unit 404 transmits a print job including the file selected by the user to the target image processing apparatus 104. Upon receiving the print job, the image processing apparatus 104 prints the picture file selected by the user based on the print setting included in the print job.

Through the processing in the flowchart, in a case where picture printing is selected by the user, print settings suitable for picture printing are applied.

Although the OS version is determined in step S702 in the flowchart example, this configuration is not intended to be a limitation. For example, a configuration may be employed that determines whether the OS can display the Photo Picker screen. In a case where the OS can display the Photo Picker screen, the processing proceeds to step S721, whereas in a case where the OS cannot display the Photo Picker screen, the processing proceeds to step S703. Since certain OS versions do not support the Photo Picker, this determination enables the provision of a more suitable file selection screen. Further, the configuration that determines whether the OS can display the Photo Picker screen is not intended to be a limitation, and a determination of whether the OS-provided file browser function is available for use may be made instead.

Further, although the file browser unit 406 instructs the OS 410 to display an OS-provided file selection screen in step S725 in the flowchart example, this configuration is not intended to be a limitation. The file browser unit 406 may be configured to invoke a picture selection application of the data processing apparatus 101. The picture selection application herein refers, for example, to Google Photo®. A configuration in which a file selected by the picture selection application is received in step S726 may be employed.

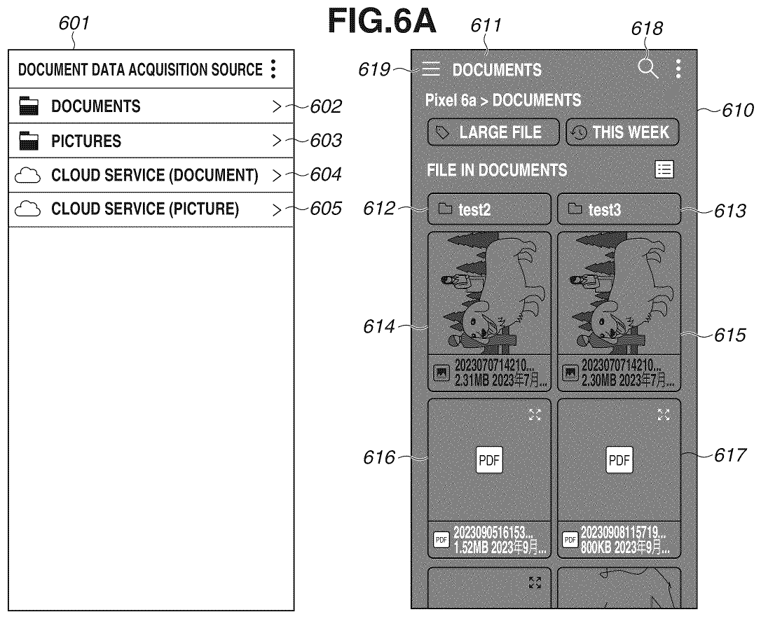

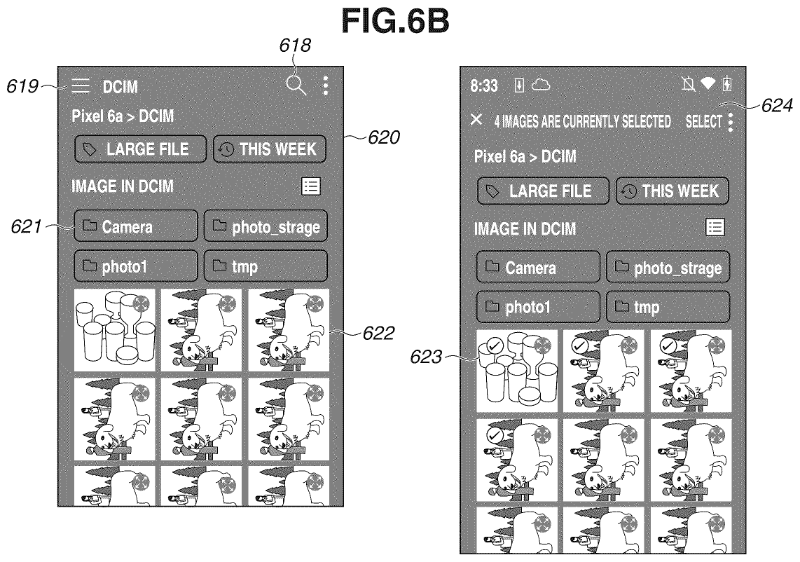

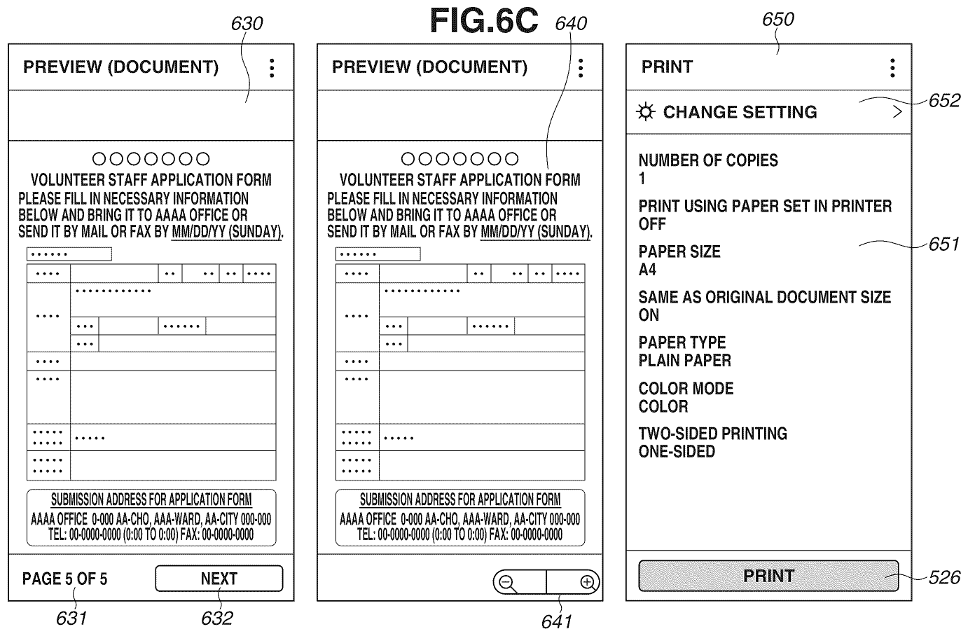

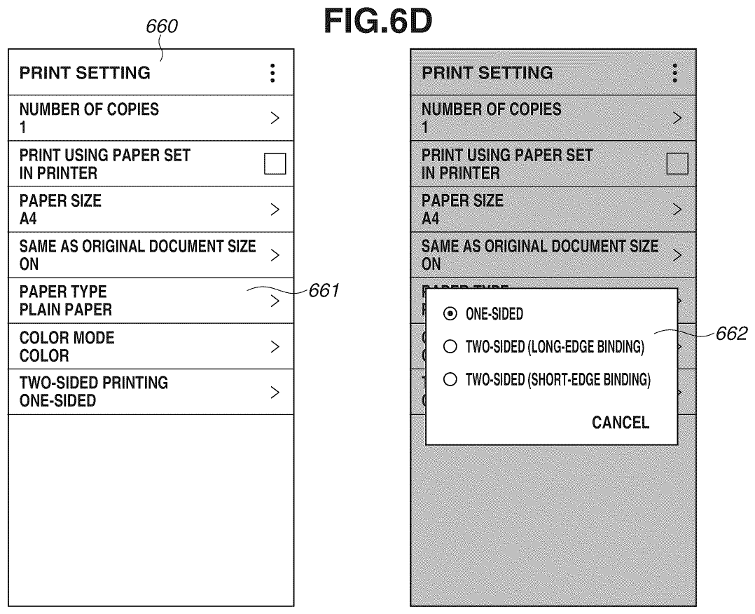

FIG. 6 illustrates examples of screens where the user selects document printing and selects a document file to be printed using the application 401. The document file is, for example, a file in Portable Document Format (PDF). The screen is displayed in a case where the document printing button 502 is selected by the user on the menu screen 501. Upon selection of the document printing button 502, the document acquisition source selection screen 601 is displayed, and the user selects a document file acquisition source.

The document acquisition source selection screen 601 is a screen for selecting information about a file to be printed. The document acquisition source selection screen 601 is displayed in a case where the document printing button 502 is selected. This screen includes a document-in-terminal button 602 configured to designate a document file in the data processing apparatus 101 as an acquisition source of a document file to be printed and a picture-in-terminal button 603 configured to designate a picture in the data processing apparatus 101 as an acquisition source of a document file to be printed. The document acquisition source selection screen 601 further includes a cloud service document button 604 configured to designate a document file in the cloud service 1 as an acquisition source of a document file to be printed and a cloud service picture button 605 configured to designate a picture in the cloud service 1 as an acquisition source of a document file to be printed. In a case where the document-in-terminal button 602 is selected, a document file selection screen 610 is displayed.

The document file selection screen 610 is an OS-provided file browser screen, and an example in which the document file selection screen 610 is a Storage Access Framework (SAF) screen provided by Android is illustrated herein. Unlike the Photo Picker screen, the SAF screen is configured to display not a list of picture files stored in the storage but a folder hierarchy, and the user selects a desired file while selecting a folder. A case where a “Document” directory is opened will be described as an example. The document file selection screen 610 displays a directory name 611 and a list of folders (612 and 613) and a list of files (614 to 617) contained in the “Document” directory. Selection of a folder from the list of folders (612 and 613) causes a transition to the selected folder, and a list of folders and files contained in the folder is displayed. In the list of files (614 to 617), files other than those having a predetermined file format (e.g., PDF) are restricted from being selected. In this case, control is applied to restrict selection of the files 614 and 615.

For example, selection of files in JPEG or PNG format is restricted. Files that cannot be selected may be displayed in a grayed-out form so that the user can recognize them. In a case where a selectable file is tapped and selected by the user from the file list, the file is designated as a file to be printed, and a transition to a preview document screen 630 occurs. Although the present exemplary embodiment allows only a single file to be selected, a configuration that allows selection of a plurality of files may also be employed. Upon selection of a search button 618, a search screen is displayed, and a file that matches a search term input by the user is displayed. Upon selection of a hamburger button 619, an option for a hierarchical layer other than the current hierarchical layer is displayed. In a case where a hierarchical layer is selected from the options, a transition to the selected hierarchical layer occurs, and a list of folders and files contained in the corresponding directory is displayed.

The preview document screen 630 is an example of a screen that presents a preview of the selected document file data to the user. On this screen, a swipe operation allows movement between preview pages. Tapping an area other than the buttons on the screen or pinching the screen in causes a transition to a preview mode 640, where the preview image can be zoomed in or out. In the preview mode 640, the image can be zoomed in or out by pinching in/out or by tapping a zoom in/out button 641. Further, other operations are performed similarly to those on the preview document screen 630. In a state in which the image is not being zoomed in or out, tapping an area other than the buttons ends the preview mode, and a transition to the preview document screen 630 occurs. Although the preview document screen 630 and the preview mode 640 are configured as separate modes in the present exemplary embodiment, the zoom in/out button 641 may be arranged on the preview document screen 630 to allow them to be executed in a single mode. A page display area 631 displays the page number of the currently displayed page. A next button 632 is a button configured to cause a transition to a document printing setting screen 650. The user may be allowed to select a range of pages to be actually printed prior to a transition to the document printing setting screen 650. This is effective in a case where, upon reviewing the print preview, the user desires to print only a portion of the file rather than the entire file. Options such as “print all pages”, “print currently displayed page”, and “print specified pages” can be provided. To print a specified range of pages, the user selects a start page and an end page.

The document print setting screen 650 is a screen for checking current print setting information and executing printing. On this screen, print settings suitable for document printing are set as default (initial) settings. The configurable print setting items and the values currently set for those items are displayed in a setting item area 651 of the screen. The currently set values herein refer to setting values read from the RAM 204. In a case no setting values are stored in the RAM 204, default values predefined for the application are used as the setting values. Although values are read from the RAM 204 herein, values may be read from the ROM 203 or the storage device 209. Further, although the screen displays a list of configurable items, only some of the setting items considered important may be displayed, or the screen may be configured to display a print preview. Selection of a change setting button 652 causes a transition to a print setting modification screen 660 for document printing. Although selection of the change setting button 652 causes a transition to the print setting modification screen 660 for document printing herein, the transition may also be triggered by tapping the setting item area 651.

The print setting modification screen 660 for document printing allows for the change of print settings and displays a print setting item 661 for document printing. In a case where an item is selected from the print setting item 661 for document printing is selected and tapped, values configurable for this item are displayed as a configurable setting item list 662 for document printing. Then, the print setting is updated with a value selected by the user from the configurable values, and the updated print setting is stored in the RAM 204. Then, the print setting modification screen 660 for document printing with the updated setting value is displayed. Although the print setting is stored in the RAM 204 herein, the print setting may be stored in the ROM 203 or the storage device 209. Further, for a setting item such as a checkbox, the user may toggle the checkbox between ON and OFF states by tapping the item.

In a case where cancellation is selected, the previously selected print setting is retained. Further, similar to the print setting item 532 for picture printing, print setting items displayed in the print setting item 661 for document printing vary depending on the image forming apparatus. Further, similar to the print setting item 532 for picture printing, a setting value considered suitable for document printing is preset as an initial value for each item in the print setting item 661 for document printing. Further, in a case where the user has previously performed printing, the setting values used for the last document printing may be stored, or the user may be allowed to configure and store default print settings.

The difference between the print setting item 532 for picture printing and the print setting item 661 for document printing is that some of the displayed options differ. Specifically, common setting items used in both document printing and picture printing, such as paper size, paper type, number of copies, and color mode, are displayed on both screens. However, setting items, such as a double-sided printing setting item and a setting item configured to match an original document size, are displayed only in the print setting item 661 for document printing. Items displayed only in the print setting item 532 for picture printing may include automatic picture correction, sharpness, border setting, and border bleed amount. This is because, in picture printing, it is uncommon to perform double-sided printing, and the user determines a printing area while previewing the picture more often rather than using automatic scaling to fit to the paper size. Conversely, since the application of image correction, such as automatic picture correction or sharpness, to a document is generally undesirable, these items are displayed only in the print setting item 532 for picture printing. As described above, separating the configurable items for document printing and picture printing improves the overall visibility of the print settings for the user, thereby enabling a printing experience with improved usability. Further, not only the configurable setting items but also the default (initial) setting values differ between picture printing and document printing. For example, the default paper size for picture printing is set to L-size, whereas a paper size suitable for document printing, such as A4, is set as the default for document printing. Further, the paper type for picture printing is set to photo paper, whereas a paper type suitable for document printing, such as plain paper, is set for document printing. These are merely examples, and the number of common items between document printing and picture printing may be increased by enabling a border setting in the print settings for document printing. The term “document printing” herein refers to printing performed in a case where the document printing button 502 is selected, and the term “picture printing” refers to printing performed in a case where the picture printing button 503 is selected. In a case where the picture-in-terminal button 603 is selected, a picture file selection screen 620 is displayed. Although a SAF screen provided by Android is displayed as an example, the Photo Picker screen described above may also be displayed. As an example, a case will be described in which a “DCIM” folder is opened. A folder list (621) and a file list (622) contained in the “DCIM” directory are displayed. Selection of a folder from the folder list (621) causes a transition to the selected folder, and a folder list and a file list contained in the selected folder are displayed. In the file list (622), only files in a selectable file format are displayed, and a preview image is displayed for each picture. For example, files in JPEG or PNG format are displayed. By tapping a preview image, the corresponding picture is selected and designated as a picture to be printed, and a transition to the preview document screen 630 occurs. Further, by long-pressing a preview image, a transition to a plurality-of-images selection mode occurs, and a check mark 623 is displayed at an upper portion of the long-pressed image to indicated that the image has been selected. Then, by tapping or long-pressing another image, the plurality of images can be selected. Selection of a select button 624 in a state in which the plurality of images being selected causes a transition to the preview document screen 630. Although a plurality of images is selectable by long-pressing the images in the foregoing configuration, a check button may alternatively be provided on each preview image, or an image selection mode button may be provided to enable selection of a plurality of images. Further, although a transition occurs from the picture file selection screen 620 to the preview document screen 630 in the present exemplary embodiment, a direct transition to the document print setting screen 650 may alternatively occur, since the image can be checked during image selection. In a case where the picture-in-terminal button 603 is selected, the setting items and the print setting values after the transition to the document print setting screen 650 are set to those suitable for document printing, as specified in the print setting item 661 for document printing. By determining configurable setting items and initial print setting values based on the user selection flow (whether the picture printing button 503 is selected or the document printing button 502 is selected), rather than based on the file format or file content, captured document data or converted document data in JPEG format obtained through scanning can be printed using settings suitable for documents. Furthermore, even in a case where document printing is selected, a picture file can be selected in addition to a document file. Similarly, a configuration may be employed that allows selection of a document file in addition to a picture file even in a case where picture printing is selected, and print setting items and print setting values suitable for picture printing may be configured to be applied even in a case where a document file is selected.

The cloud service document button 604 is configured to set a cloud service as a document file acquisition source. First, in order to determine a cloud service from which a document file is to be acquired, the user is prompted to select a cloud service. Then, communication is performed with the selected cloud service to execute a login operation. Thereafter, a document file stored in the cloud service is displayed.

The cloud service picture button 605 triggers operations similar to those in a case where the cloud service document button 604 is pressed. However, the files displayed are picture files stored in the cloud service. After the user selects a cloud service, the file selection function can also be executed by the cloud service.

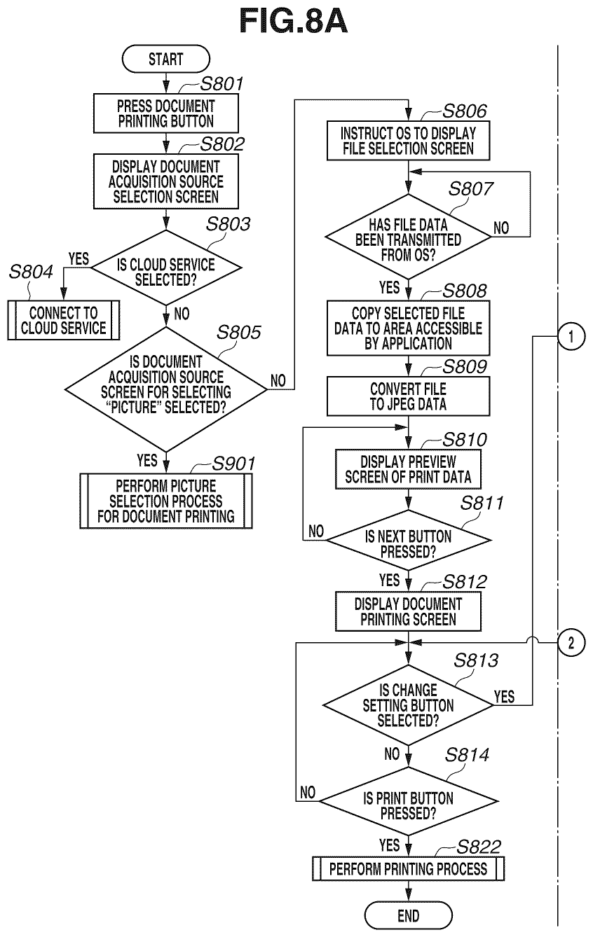

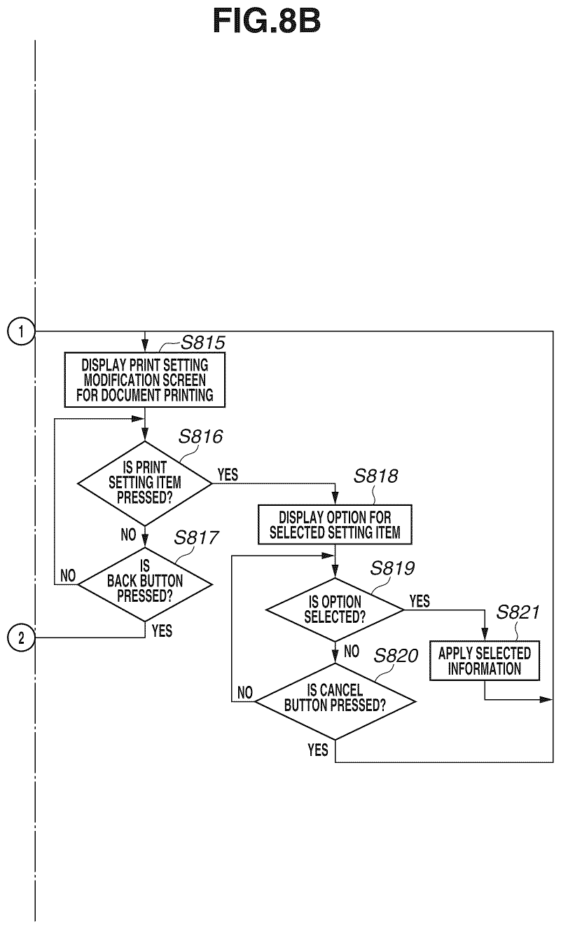

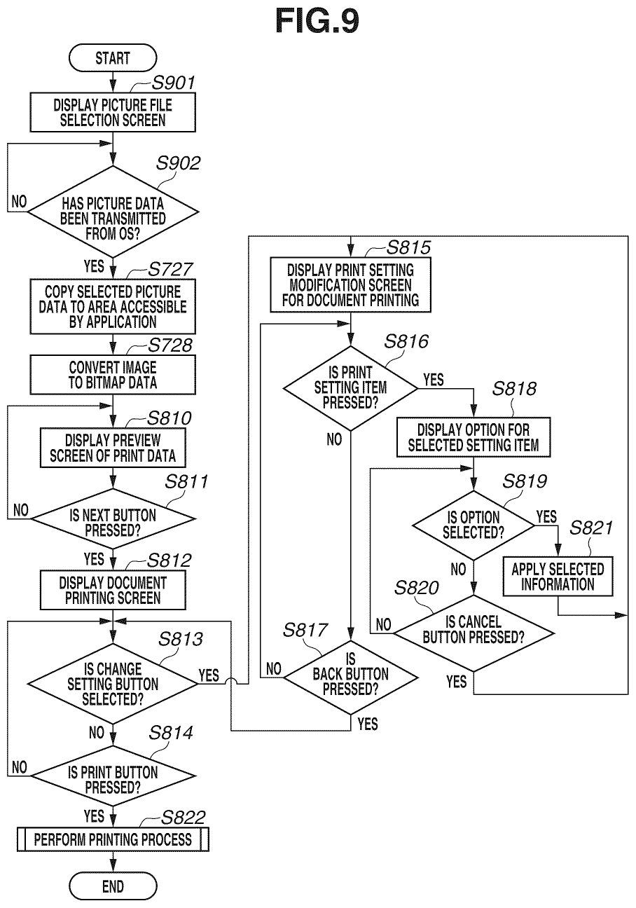

A process for selecting a file for document printing and printing the selected file by the application 401 will be described with reference to flowcharts in FIGS. 8 and 9.

Each step in FIGS. 8 and 9 is realized by the CPU 202 by executing a program stored in the ROM 203 or the storage device 209.

In step S801, the UI unit 402 receives a selection of the document printing button 502.

In step S802, the UI unit 402 displays the document acquisition source selection screen 601. In step S803, the control unit 404 determines whether the cloud service button (604 or 605) is selected on the document acquisition source selection screen 601. In a case where the cloud service button (604 or 605) is selected (YES in step S803), the processing proceeds to step S804. Otherwise (NO in step S803), the processing proceeds to step S805. In step S804, the control unit 404 connects to the cloud service and receives a user operation to select a file from the file list stored in the cloud storage. In a case where a selection of a file is received, the file may be set as a file to be printed, and the processing may proceed to step S806 or S807.

In step S805, the control unit 404 determines whether a document acquisition source screen for selecting “picture” is selected, e.g., whether the picture-in-terminal button 603 is selected or the document-in-terminal button 602 is selected. In a case where picture is selected (YES in step S805) the processing proceeds to step S901. Otherwise (NO in step S805) the processing proceeds to step S806. For example, in a case where the picture-in-terminal button 603 is selected (YES in step S805), the processing proceeds to step S901, whereas in a case where the document-in-terminal button 602 is selected (NO in step S805), the processing proceeds to step S806.

In step S806, the file browser unit 406 instructs the OS 410 to display an OS-provided file selection screen. For example, the file browser unit 406 instructs the OS 410 to display a SAF screen. In this case, for example, the document file selection screen 610 is displayed.

In step S807, the control unit 404 determines whether a document file has been transmitted from the OS 410. In a case where a document file has been transmitted (YES in step S807), the processing proceeds to step S808. Otherwise (NO in step S807), the process of step S807 is repeated. In a case where a file is selected on the document file selection screen 610 by the user, the selected file is transmitted from the OS 410 to the application 401. Thus, the processing proceeds to step S808.

In step S808, the control unit 404 copies the document file selected by the user to a memory area accessible by the application 401. In step S809, the control unit 404 converts the selected document file to JPEG data. Then, in step S810, the UI unit 402 displays the preview document screen 630 of the selected file.

In step S811, the control unit 404 determines whether the next button 632 is pressed. In a case where the next button 632 is pressed (YES in step S811), the processing proceeds to step S812. Otherwise (NO in step S811), the processing returns to step S810. In step S812, the UI unit 402 displays the document printing setting screen 650.

In step S813, the control unit 404 determines whether the change setting button 652 is selected. In a case where the change setting button 652 is selected (YES in step S813), the processing proceeds to step S815. Otherwise (NO in step S813), the processing proceeds to step S814.

In step S815, the UI unit 402 displays the print setting modification screen 660 for document printing. In step S816, the control unit 404 determines whether an item is selected from the print setting item 661 for document printing. In a case where an item is selected (YES in step S816), the processing proceeds to step S818. Otherwise (NO in step S816), the processing proceeds to step S817.

In step S817, the control unit 404 determines whether the back button is pressed. In a case where the back button is selected (YES in step S817), the processing returns to step S813. Otherwise (NO in step S817), the processing returns to step S816.

In step S818, the UI unit 402 displays the configurable setting item list 662 for document printing. In step S819, the control unit 404 determines whether a setting value is selected from the options in the configurable setting item list 662 for document printing. In a case where a setting value is selected (YES in step S819), the processing proceeds to step S821. Otherwise (NO in step S819), the processing proceeds to step S820.

In step S820, the control unit 404 determines whether the cancel button is pressed. In a case where the cancel button is pressed (YES in step S820), the processing returns to step S815. Otherwise (NO in step S820), the processing returns to step S819.

In step S821, the CPU 202 instructs the UI unit 402 to apply the selected setting value information to the print setting modification screen 660 for document printing, and the processing returns to step S815.

In step S814, the control unit 404 determines whether the print button 526 is selected. In a case where the print button 526 is selected (YES in step S814), the processing proceeds to step S822. Otherwise (NO in step S814), the processing returns to step S813.

In step S822, the control unit 404 transmits a print job including the file selected by the user to the target image processing apparatus 104. Upon receiving the print job, the image processing apparatus 104 prints the document file selected by the user based on the print setting included in the print job.

Next, a process from step S901 will be described with reference to FIG. 9.

In step S901, the UI unit 402 displays the picture file selection screen 620.

In step S902, the control unit 404 determines whether picture data has been transmitted from the OS 410. Specifically, in a case where a picture is tapped on the picture file selection screen 620 or the select button 624 is selected, picture data is transmitted from the OS 410. In a case where picture data has been transmitted (YES in step S902), the processing proceeds to step S727, whereas in a case where no picture data has been transmitted (NO in step S902), waiting for the determination in step S902 continues. The subsequent processing is the same as in FIGS. 7 and 8, and the same reference numerals are assigned to the same processes, with descriptions thereof omitted.

Through the processing in the flowcharts described above, in a case where document printing is selected by the user, print settings suitable for documents are applied. Even in a case where a picture file (e.g., file in JPEG or PNG format) is selected when document printing is selected, print settings suitable for documents are applied. The configurable print setting items and initial print setting values for the same picture file vary depending on whether the picture printing button 503 is selected or the document printing button 502 is selected.

Although the document file (e.g., PDF) selection screen and the picture file selection screen are separate screens in the above-described example, a single screen may be configured to allow the selection of both document and picture files.

Further, a configuration may be employed in which an OS-provided file selection screen is consistently displayed for both picture and document selection. Further, although the OS-provided file selection screen is a Photo Picker screen in the example of the flowchart in FIG. 8, the OS-provided file selection screen may also be a SAF screen.

Further, the present disclosure can also be realized by executing the following process. Specifically, software (program) configured to realize the functions of the above-described exemplary embodiment is supplied to a system or apparatus via a network or various storage media, and a computer (or CPU or micro-processing unit (MPU)) of the system or apparatus reads the program and executes the read program. In this case, the computer program and the storage medium storing the computer program constitute the present disclosure.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-107515, filed Jul. 3, 2024, which is hereby incorporated by reference herein in its entirety.

What is claimed is:

1. A control method of a data processing apparatus, the control method comprising:
executing a first display control to display a screen configured to prompt a user to select whether to perform document printing or picture printing;
executing a second display control to display a file selection screen used to select a file to be printed, the file selection screen including a file corresponding to printing selected on the screen; and
transmitting an instruction to print the file selected on the file selection screen to an image processing apparatus,
wherein in a case where the document printing is selected on the screen, a print setting corresponding to the document printing is set, whereas in a case where the picture printing is selected on the screen, a print setting corresponding to the picture printing is set, and in a case where the document printing is selected on the screen and a file indicating a picture is selected on the file selection screen, the print setting corresponding to the document printing is set.

2. The control method according to claim 1, wherein the screen is a home screen configured to receive an operation from the user to select a function to be executed.

3. The control method according to claim 1, wherein in a case where the document printing is selected on the screen, a print setting item corresponding to the document printing is configured to be changed, whereas in a case where the picture printing is selected on the screen, a print setting item corresponding to the picture printing is configured to be changed.

4. The control method according to claim 3, wherein the print setting item corresponding to the document printing includes a double-sided printing setting item and a setting item configured to match an original document size, and the print setting item corresponding to the picture printing includes an automatic picture correction setting, a sharpness setting, and a border setting.

5. The control method according to claim 1, wherein in a case where the document printing is selected on the screen, a print setting value corresponding to the document printing is set as a default value, whereas in a case where the picture printing is selected on the screen, a print setting value corresponding to the picture printing is set as a default value.

6. The control method according to claim 5, wherein the print setting value corresponding to the document printing is plain paper, and the print setting value corresponding to the picture printing is photo paper.

7. The control method according to claim 1, further comprising executing a third display control to display, in a case where the picture printing is selected on the screen, a selection screen configured to prompt the user to select whether to display a file stored in the data processing apparatus, a file stored in a cloud, or a file stored in another application.

8. The control method according to claim 1, further comprising executing a third display control to display, in a case where the document printing is selected on the screen, a selection screen configured to prompt the user to select whether to display a document file stored in the data processing apparatus, a picture file stored in the data processing apparatus, or a file stored in a cloud.

9. The control method according to claim 1, wherein the file indicating a picture is a file in Joint Photographic Experts Group (JPEG) or Portable Network Graphics (PNG) format.

10. The control method according to claim 1, wherein in the second display control, an operating system (OS) running on the data processing apparatus is instructed to display the file selection screen.

11. The control method according to claim 1, wherein in a case where the document printing is selected on the screen, the file selection screen is configured to select a plurality of files to be printed.

12. A non-transitory computer-readable storage medium that stores a program for causing a computer of a data processing apparatus to execute a control method comprising:
executing a first display control to display a screen configured to prompt a user to select whether to perform document printing or picture printing;
executing a second display control to display a file selection screen used to select a file to be printed, the file selection screen including a file corresponding to the printing selected on the screen; and
transmitting an instruction to print the file selected on the file selection screen to an image processing apparatus,
wherein in a case where the document printing is selected on the screen, a print setting corresponding to the document printing is set, whereas in a case where the picture printing is selected on the screen, a print setting corresponding to the picture printing is set, and in a case where the document printing is selected on the screen and a file indicating a picture is selected on the file selection screen, the print setting corresponding to the document printing is set.

13. A data processing apparatus comprising:
a first display control unit configured to display a screen configured to prompt a user to select whether to perform document printing or picture printing;
a second display control unit configured to display a file selection screen used to select a file to be printed, the file selection screen including a file corresponding to the printing selected on the screen; and
a transmission unit configured to transmit an instruction to print the file selected on the file selection screen to an image processing apparatus,
wherein in a case where the document printing is selected on the screen, a print setting corresponding to the document printing is set, whereas in a case where the picture printing is selected on the screen, a print setting corresponding to the picture printing is set, and in a case where the document printing is selected on the screen and a file indicating a picture is selected on the file selection screen, the print setting corresponding to the document printing is set.
